(19) United States
(12) Patent Application Publication
(10) Pub. No.: US 2015/0308182 A1
(43) Pub. Date: Oct. 29, 2015

(54) FOLDING WINDOW

(71) Applicants: Mark S. Gionta, Rochester, NY (US); Timothy H. Forster, Fairport, NY (US); Mark R. Hosier, Marion, NY (US); Walter J. Roth, Rochester, NY (US)

(72) Inventors: Mark S. Gionta, Rochester, NY (US); Timothy H. Forster, Fairport, NY (US); Mark R. Hosier, Marion, NY (US); Walter J. Roth, Rochester, NY (US)

(21) Appl. No.: 14/260,381

(22) Filed: Apr. 24, 2014

(51) Int. Cl. E06B 3/48; E06B 9/52

(52) U.S. Cl. CPC E06B 3/483; E06B 9/52

(57) ABSTRACT

A double hung window has upper and lower window sashes in a window frame including a header, sill, and a vertical jamb on each side. The upper sash is pivotally connected to the frame header for inward pivotal movement on a horizontal axis. The lower sash is pivotally connected to the upper sash for reverse pivotal movement on a parallel horizontal axis, whereby to fold the lower sash up and under the upper sash. A tape balance atop the frame applies a lifting force to the lower sash. Grasp and inward pull of a handle pulls lower and upper sashes inward from a dead center condition, thereby enabling the tape balance to effectively assist in pulling the sashes upward. A screen, separate from the window sashes, is removably mounted on the outer face of the window frame.

### CROSS-REFERENCE TO RELATED APPLICATION

This is a continuation-in-part of our copending applicaton Ser. No. 13/986,497 which was filed on May 9, 2013 and is now abandoned.

### BACKGROUND OF THE INVENTION

1. Field of the Invention

This invention relates to window structure, and specifically to a window structure that is foldable upward, collapsible upon itself to open the window. The purposes of this are to enhance view by removing window structure from the field of view, to open living spaces to the outdoors for air flow and, when necessary, to provide fully-open personal egress through the window.

A traditional double hung window, whether it is open or dosed, does to some extent interfere with and impair the field of view through the window. The window of this invention, when dosed, has the same appearance as a traditional double hung window so it blends seamlessly into traditional architecture. But, when fully open, it does not obstruct or interfere with the field of view through the window.

2. Prior Art

Traditional prior art double hung windows have upper and lower sashes which are separate from each other and are slidable up and down independently of each other. Inherently, such a window cannot be more than half open.

Some double hung windows have upper and lower sashes which are removable for cleaning and maintenance, but such removal of sashes is not a practical way to open the window or to enhance the view through it.

The most relevant prior art that we know of known is described in a U.S. Patent Application of Christian Guillemette; Pub. No. 2012/0117882; published May 17, 2012. The relevance of Guillemette is discussed below, near the end of the Detailed Description.

### SUMMARY OF THE INVENTION

An object of this invention is to provide a window with the appearance of a traditional double hung window when dosed, and which is virtually fully openable.

In summary, this invention is a double hung window with upper and lower sashes in a window frame. The upper sash is pivotally connected to the frame header for inward pivotal movement on a horizontal axis. The lower sash is pivotally connected to the upper sash for reverse pivotal movement on a parallel horizontal axis, whereby to fold the lower sash up and under the upper sash.

A tape balance atop the frame applies an upward force to the lower sash. Grasp and inward pull of the upper rail of the lower sash initiates the inward and upward folding action of the sashes from their vertical closed condition, thereby enabling manual upward movement of the sashes with an assist from the tape balance. A screen, separate from the window sashes, is removably mounted on the outer face of the window frame.

### DRAWINGS

In the accompanying drawings:

FIG. 1 is a front view, looking outward, of a window of this invention.

FIG. 2 is a view from the right side FIG. 1, on the plane 2-2 of FIG. 1.

FIG. 2A is an enlarged perspective view of the circled portion of FIG. 2.

FIG. 3 is a view, similar to FIG. 2, of the window in one stage of its upward folding.

FIG. 4 is a view, similar to FIG. 3, of the window in a further stage of its upward folding.

FIG. 5 is a view, similar to FIG. 4, of the window now fully open.

FIG. 6 is a view similar to FIG. 1, showing the window fully open.

FIG. 7 is an enlarged plan view on the plane 7 at the left end of FIG. 1.

### DETAILED DESCRIPTION

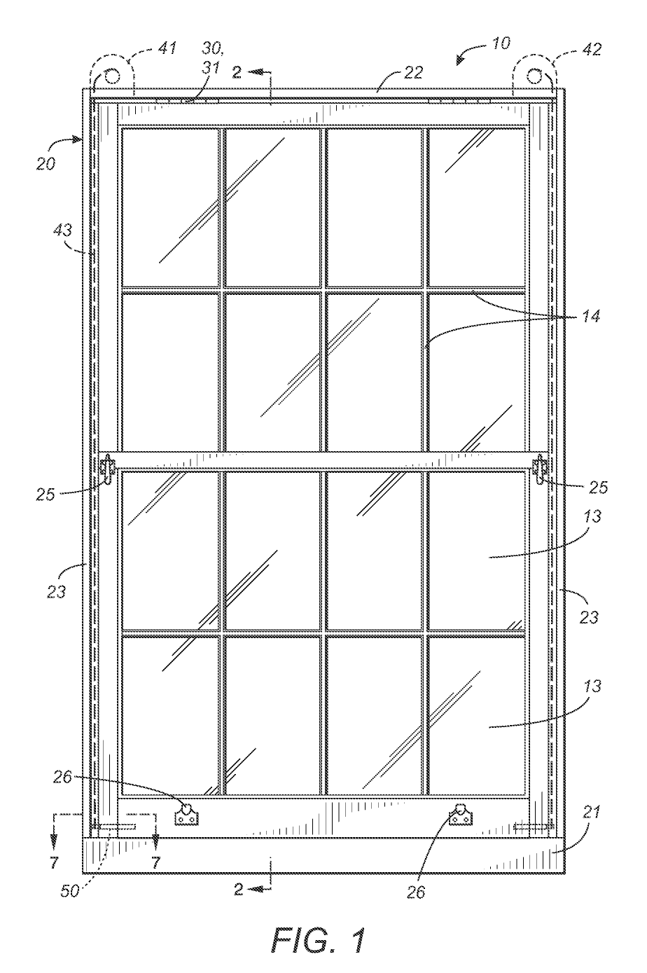

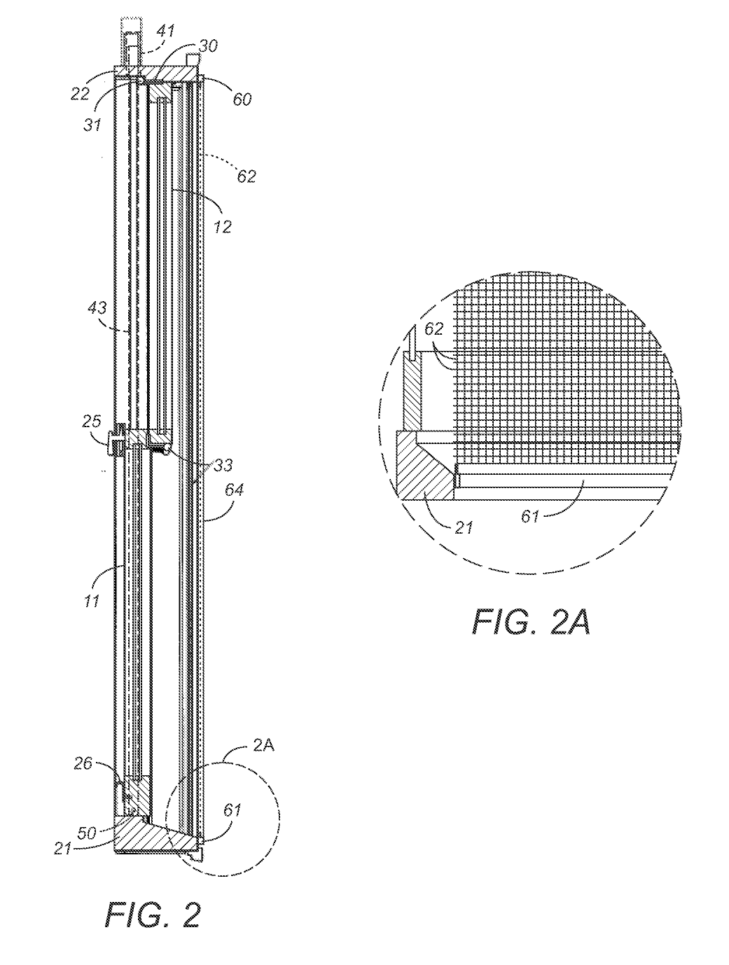

With reference now to FIGS. 1 and 2, a window 10 includes a lower sash 11 and upper sash 12, each sash including muntins 14 dividing the sashes into individual panes or pane areas 13. Sashes 11, 12 are mounted in a window frame 20 which includes a window sill 21, a top header 22, and a vertical jamb 23 on each side. In FIG. 1, the dosed window 10 has the aesthetic appearance of a traditional double hung window.

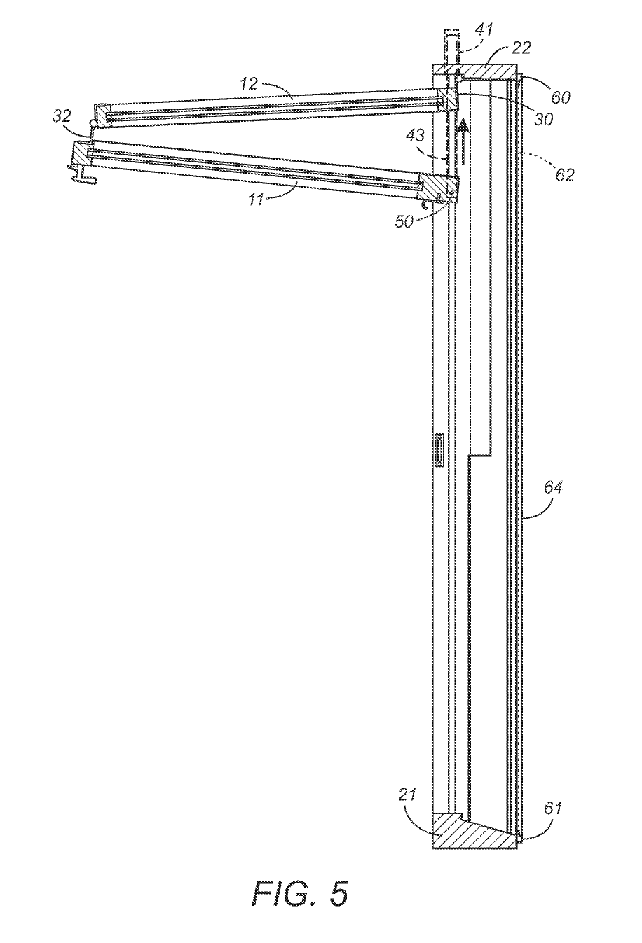

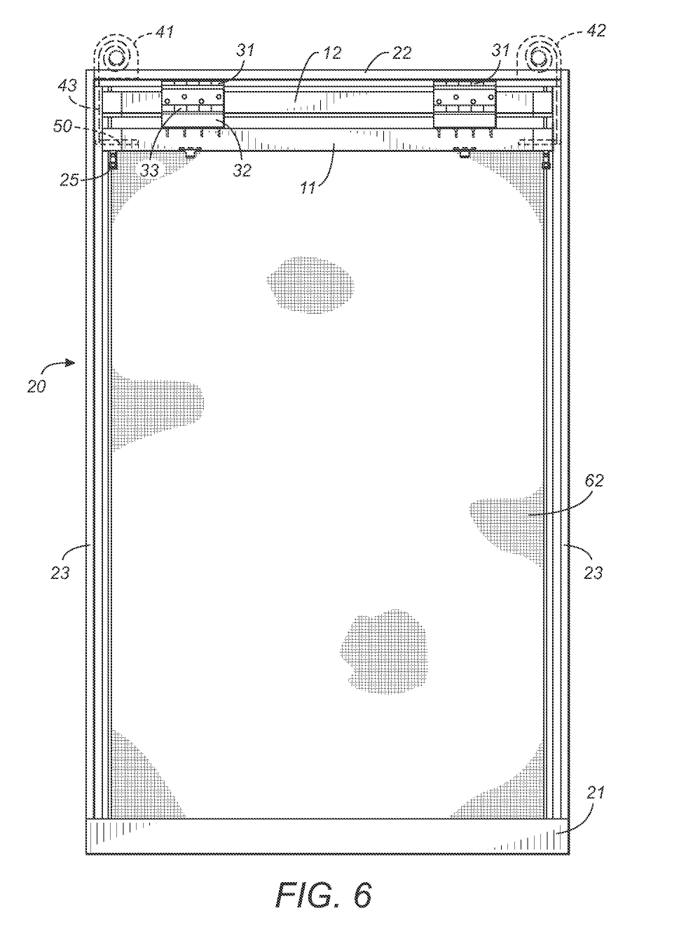

Reference is now to FIGS. 2-6 and FIG. 2A. A screen 62, in a frame of top 60, bottom 61, and side members 64, is mounted on the outer face of the window 10, the right side of the drawing figures. The screen 62 in FIG. 6 is omitted from FIG. 1 only for the sake of FIG. 1 clarity. The screen frame 60, 61, 64 is removably mounted and secured in the window frame 20 by fasteners or other standard devices which are well known in the art.

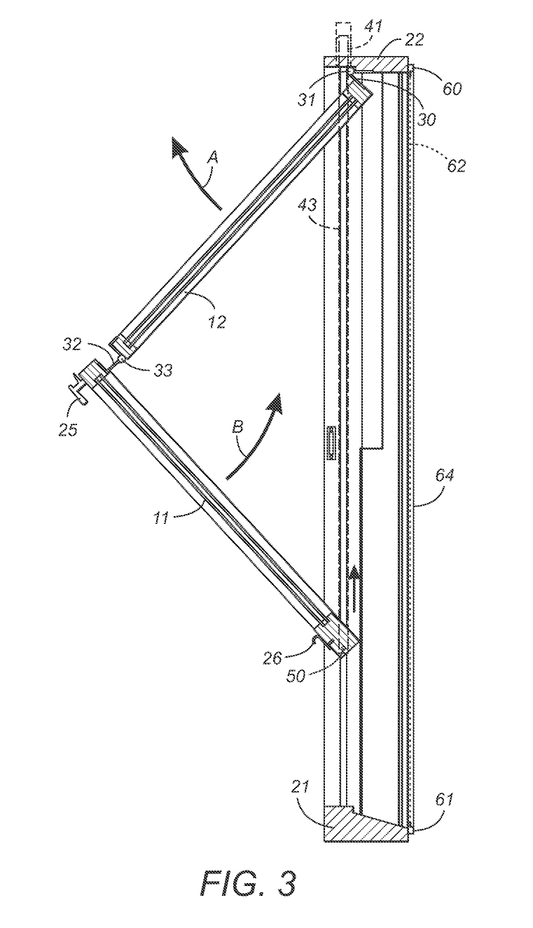

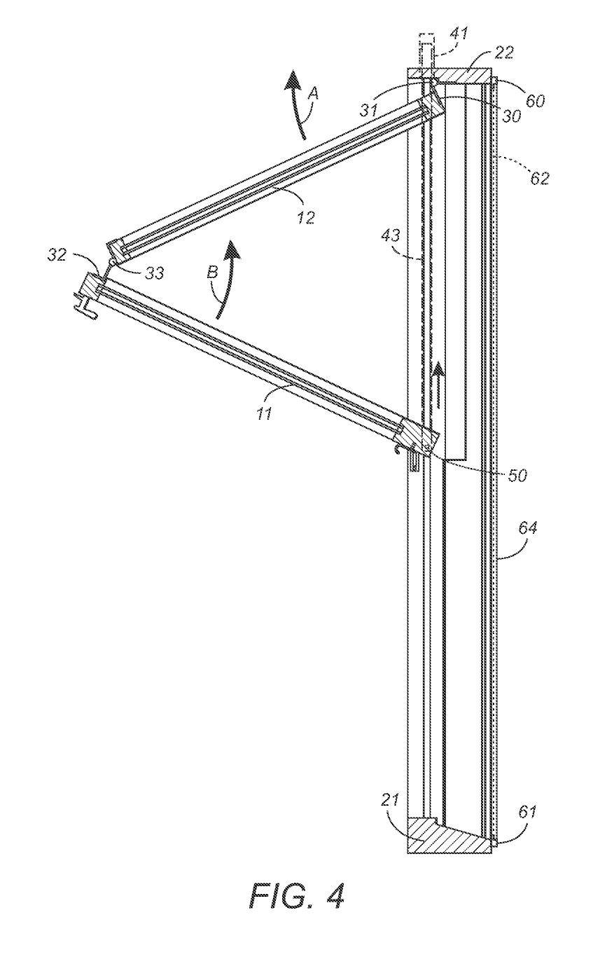

Reference is now primarily to FIGS. 2-5. The upper sash 12 of the window 10 is connected to the frame header 22 by a hinge 30 for inward pivotal movement on a horizontal axis 31 relative to the window frame 20. This pivotal movement is clockwise, inward and upward, as indicated by the arrow A in FIGS. 3, 4.

The lower sash 11 is similarly connected to the bottom of sash 12 by a hinge 32 for pivotal movement on a horizontal axis 33 relative to the upper sash 12. This pivotal movement is counter-clockwise, upward toward the upper sash 12, as indicated by the arrow B in FIGS. 3, 4.

As can be seen in FIGS. 2-6, the screen 62 remains in place independently of, and unaffected by, opening and dosing operations of the window sashes 11, 12.

Left and right tape balances 41, 42 are mounted at top left and top right of the window frame 20. Each tape balance includes an extensible tape 43, wound in tension and extending from their housings down along their respective jambs 23, for connection with left and right bottom ends of the lower sash 11.

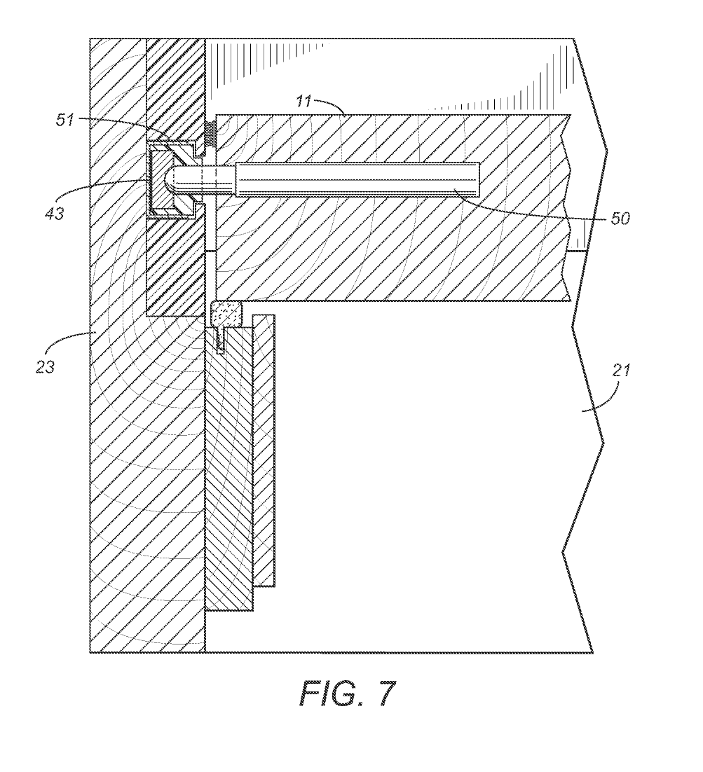

Referring now also to FIG. 7, the tapes are in tension, urging the sash 11 upward. The lower sash 11 includes left and right pins 50 extending sideways out from respective bottom corners. These pins engage guide tracks 51 in their respective jambs, which guide the pins 50 in their up and down movements. In short, the pins and guide tracks keep the lower sash in line between left and right jambs 23. Left and right tapes 43 are connected to respective left and right sash pins 50 to move up and down with the pins 50 and lower sash 11.

Hand grips 25 at the top of the lower sash 11 facilitate the start of window opening action, whereupon the tape balances 41, 42 assist the upward movement of the sashes. Their upward pull also weight-balances the sashes to hold them at any intermediate open position.

Our window and system differs significantly from the prior art Guillemette publication referenced above, as follows:

In our window, upper and lower sashes are horizontally offset, in parallel planes, exhibiting the proportions, depth, and aesthetics of traditional double hung windows. And, when the window is dosed, the bottom rail of the upper sash is behind, not above, the upper rail of the lower sash, thereby reducing interference with the window aperture.

Our upfolded sashes are not visible from out-of-doors. In other words, our system creates not only the reality, but the appearance, of an open porch.

As a storefront window, whether it is open or dosed it does not encroach on the exterior sidewalk right-of-way. A passing pedestrian cannot bump into it.

Because our window opens fully, top to bottom, it also provides emergency egress without loss of aesthetics. This indeed is a design problem that vexes architects who wish to use double hungs in bedrooms where, generally, at least one egress window is required.

The foregoing description of a preferred embodiment of this invention is illustrative. The concept and scope of the invention are not limited by such details but only by the following claims.

What is claimed is:

1. A double hung window including upper and lower window sashes disposed in parallel planes in a window frame;
said window frame including a header, sill, and left and right jambs; said sashes each including top, bottom, and side portions;
said upper sash depending from said header, and pivotally connected thereto for inward and upward pivotal movement on a horizontal axis relative to said window frame;
said lower sash depending from said upper sash, and pivotally connected thereto for pivotal movement on a horizontal axis relative to said upper sash, whereby to fold said lower sash up and under said upper sash;
said window sashes being substantially ^{.}fully openable, with said upper and lower sashes folded to each other in a horizontal attitude extending inward from said header; and
a framed screen removably mounted on said window frame outward of said upper and lower sashes, said screen being independent of, and out of the way of, said pivotal movements of said sashes;
said window, fully openable from within, providing emergency egress therethrough

2. A double hung window as defined in claim 1, further including a handle on said top portion of said lower sash with which to manually initiate said inward pivotal movement.

3. A double hung window as defined in claim 2, further including balancing means extending from said window frame and connected in tension to said lower sash to urge said lower sash upward, thereby to assist said pivotal movements and to hold said sashes at intermediate open positions, as desired.

4. A double hung window including upper and lower window sashes disposed in a window frame having a horizontal top header, a horizontal bottom sill, and a vertical jamb on each side;
said upper sash connected to said top header for inward pivotal movement on a horizontal axis relative to said frame;
said lower sash connected to said upper sash for reverse pivotal movement on a horizontal axis relative to said upper sash, whereby to fold said lower sash up and under said upper sash;
means to grasp said lower sash to pull said lower and upper sashes inward, thereby to initiate said pivotal movements; and
left and right tape balances disposed atop said frame, each including a tape extending therefrom down along respective left and right jambs and operatively connected to said lower sash to urge said lower sash upward, thereby to assist said pivotal movements.
